(19) United States
(12) Patent Application Publication
(10) Pub. No.: US 2012/0143693 A1
(43) Pub. Date: Jun. 7, 2012

(54) Targeting Advertisements Based on Emotion

(75) Inventors: WOOK JIN CHUNG, KIRKLAND, WA (US); PRITESH PATWA, REDMOND, WA (US); MARTIN MIROSLAVOV MARKOV, BELLEVUE, WA (US)

(73) Assignee: MICROSOFT CORPORATION, REDMOND, WA (US)

(21) Appl. No.: 12/958,775

(22) Filed: Dec. 2, 2010

(51) Int. Cl. G06Q 30/00; G06F 15/16

(52) U.S. Cl. 705/14.66; 705/14.4; 709/224

(57) ABSTRACT

A computer system, a computer-implemented method, and computer readable media configured to target advertisements based on emotional states are provided. Advertisers specify desired emotional states of users they intend to target with advertisements. Advertisers also provide emotional tags having the desired emotional state of users that should see the advertisements linked to the emotional tags. Online activities for users are obtained and processed to assign emotional states to the users. An advertisement engine selects advertisements that are emotionally compatible based on the assigned emotional states and the desired emotional states provided by the advertisers.

### BACKGROUND

Conventionally, a user enters a search query in a web browser executing on a user's computer. The search query represents a search intent for the user. The search query entered into the web browser is sent to a search engine. Advertisers may bid on the search query to have their advertisements included in a search results page that is transmitted from the search engine to the user's computer.

Some advertisers may choose to target delivery of the advertisement to users based on gender, time of day, or location. Advertisers that have bid the highest will have optimal placement of their advertisements on the search results page that the search engine sends to the user's web browser. For example, Jim's Pizza may be an advertiser in “Bellevue, Washington,” that only wants to show its advertisements to users who are searching for local information around Bellevue. When a user submits a search query in the web browser for “Bellevue, Washington,” to the search engine, a results page that includes the advertisement for Jim's Pizza may be returned to the web browser. If Jim's Pizza was the highest bidding advertiser, the advertisement for Jim's Pizza would receive optimal placement. If Jim's Pizza was not the highest bidding advertiser, the advertisement for Jim's Pizza would receive suboptimal placement.

The conventional advertisement systems may have difficulty presenting an appropriate advertisement at the proper time and proper place because keywords fail to completely convey a user's context. For instance, a user that may enter “bar” as keyword. The conventional advertisement system receives the keyword but has many advertisers that bid on this keyword. The conventional advertisement systems are unable to extract additional context from the user at the time of query that would properly fit the user's current context. Therefore, advertisers may have difficulty utilizing the conventional advertisement systems to effectively articulate types for users that should be included in the intended audience for its advertisements.

### SUMMARY

Embodiments of the invention include computer-readable media, methods, and computer systems that manage and select advertisements that are presented to a user.

A computer system is configured to execute a method to deliver advertisements based on emotional states. Advertisers provide targeting data that includes the desired emotional states of users it intends to target. Advertisers may also provide advertisements that vary with the desired emotional states. Additionally, the advertisers may associate, with the advertisements, emotional states that represent emotional contexts for the content of the advertisements.

The computer system monitors online activity of users. The online activity is processed to identify a tone of content the users interact with during a time period. The computer system also receives indications of the users' reactions to the content. In turn, the computer system assigns emotional states to the users based on the tone of the content and the indications of the users' reactions. Advertisements are selected for delivery to the users by the computer system. The advertisements may be selected based on emotional states assigned to the users or the emotional states associated with the advertisements. The computer system delivers the selected advertisements with the highest monetization values to the users that are emotionally compatible. If the assigned emotional state of the user is unavailable, advertisements associated with neutral emotional states are selected and the selected advertisements with the highest monetization value are delivered to the user.

This Summary is provided to introduce a selection of concepts in a simplified form that are further described below in the Detailed Description. This Summary is not intended to identify key features or essential features of the claimed subject matter, nor is it intended to be used as an aid in isolation in determining the scope of the claimed subject matter.

### BRIEF DESCRIPTION OF THE DRAWINGS

FIG. 1 is network diagram that illustrates an exemplary computing environment, according to embodiments of the invention;

FIG. 2 is a block diagram that illustrates exemplary emotional states utilized by an advertisement engine in the computing environment to target advertisements, according to embodiments of the invention; and

FIG. 3 is a logic diagram that illustrates an exemplary computer-implemented method for determining emotional states, according to embodiments of the invention.

### DETAILED DESCRIPTION

This patent describes the subject matter for patenting with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and “block” may be used herein to connote different elements of methods employed, the terms should not be interpreted as implying any particular order among or between various steps herein disclosed unless and except when the order of individual steps is explicitly described. Further, embodiments are described in detail below with reference to the attached drawing figures, which are incorporated in their entirety by reference herein.

As utilized herein, the term “component” refers to any combination of hardware, software, or firmware.

Embodiments of the invention leverage emotion to target advertisements to users. Users are assigned emotional states by an advertisement engine based on monitored activities. Advertisers provide the advertisement engine with advertisements and desired emotional states of users that the advertisers intend to target. In some embodiments the advertiser may provide multiple versions of an advertisement based on the desired emotional state of the intended audience. In turn, the advertisement engine selects advertisements that are emotionally compatible with the assigned emotional state of the user. Advertisers that target emotions may increase the likelihood of displaying an advertisement that is properly in tune with the assigned emotional state of the user.

The monitored activities of the users are processed by a computer system to assign emotional states to the users. The emotional states are stored in an emotional state database along with identifiers for the users. An advertisement database stores the advertisements and targeting information, including desired emotional states, provided by the advertisers. The advertisement engine receives a request for an advertisement from a client device. The request includes the identifier of a user that is interacting with the client device. The advertisement engine searches the emotional state database to identify the assigned emotional state of the user. In turn, the advertisement database is searched to select advertisements that are available for the user consistent with the targeting information associated with the advertisements. In turn, the advertisement engine transmits, to the user, the selected advertisement with best monetization value.

For instance, OMG, Inc. is an advertiser that owns bowling alleys and lounges specializing in birthday parties in Seattle; New York; California, Washington, D.C.; Chicago; and Miami. OMG has advertisements that target birthday parties for children during the day and advertisements that target birthday parties for adults at night. In one advertisement an animated bowling ball races down a lane to smash bowling pins, which triggers fireworks and balloons. The balloons rise and say “CELEBRATE YOUR BIRTHDAY WITH A BANG AT OMG!”

OMG's advertising campaign includes location targeting and age targeting. OMG's brand-monitoring firm reports that the current advertising campaign has received some negative feedback. The brand-monitoring firm reports, “OMG's ad needs to calm down. There is too much BANG on it.” “I don't think I can handle such ruckus while I chaperon my son's birthday,” etc.

OMG intends for its advertisements to resonate with emotional states such as “excitement,” “happiness,” and “celebration.” But those emotional states are not compatible with users assigned emotional states of “distress” or “sadness” based on the online activities of the users. Users assigned emotional states of “distress” or “sadness” may be offended or annoyed by OMG's advertisement if it is displayed to them during the period of time that the users are assigned the emotional states of “distress” or “sadness.” To reduce the likelihood of this type of reaction to its advertisements, OMG logs into the advertisement engine and updates its advertising campaign by enabling emotional targeting and specifying that its advertisements should be displayed to users having a positive emotional state.

Accordingly, in some embodiments, a computer system for managing and selecting advertisements includes client devices communicatively connected to an advertisement engine, e.g., search engine, and advertisement management system. The client devices may monitor users' online actives, such as generating search terms provided by the users of the client devices and transmitting the search terms to a search engine. The search engine receives the user search terms and communicates with an advertisement engine to receive advertisements that are emotionally compatible with emotional states assigned to the users.

As one skilled in the art appreciates, the computer system includes hardware, software, or a combination of hardware and software. The hardware includes processors and memories configured to execute instructions stored in the memories. In one embodiment, the memories include computer-readable media that store a computer-program product having computer-useable instructions for a computer-implemented method. Computer-readable media include both volatile and nonvolatile media, removable and nonremovable media, and media readable by a database, a switch, and various other network devices. Network switches, routers, and related components are conventional in nature, as are means of communicating with the same. Computer-readable media are computer-storage media. Computer-storage media include media implemented in any method or technology for storing information. Examples of stored information include computer-useable instructions, data structures, program modules, and other data representations. Computer-storage media include, but are not limited to, random access memory (RAM), read only memory (ROM), electrically erasable programmable read only memory (EEPROM), flash memory or other memory technology, compact-disc read only memory (CD-ROM), digital versatile discs (DVD), holographic media or other optical disc storage, magnetic cassettes, magnetic tape, magnetic disk storage, and other magnetic storage devices. These memory components can store data momentarily, temporarily, or permanently.

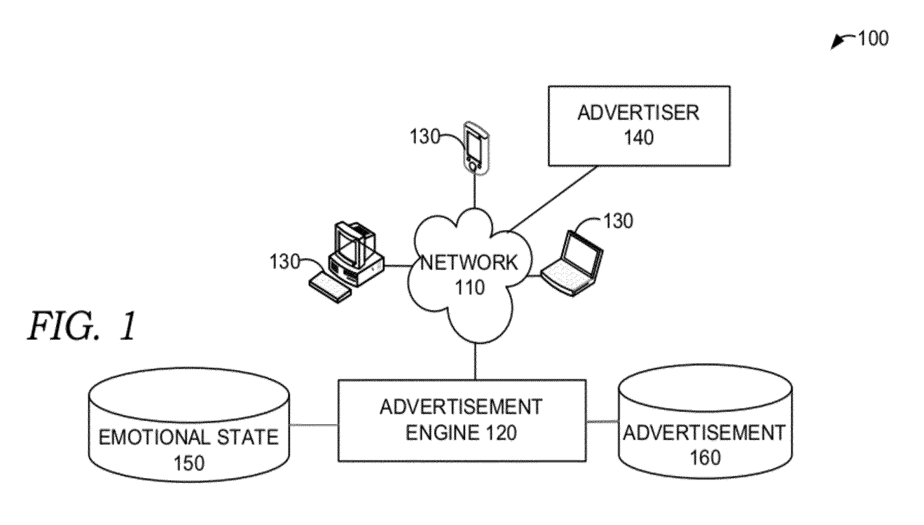

FIG. 1 is network diagram that illustrates an exemplary computing environment, according to embodiments of the invention. The computing environment 100 includes a network 110, an advertisement engine 120, client devices 130, an advertiser 140, an emotional state database 150, and an advertisement database 160.

The network 110 is configured to facilitate communication between the client devices 130 and the advertisement engine 120. The network 110 also facilitates communication between the advertisement engine 120 and the advertiser 140. The network 110 may be a communication network, such as a wireless network, local area network, wired network, or the Internet. In an embodiment, the client devices 130 may communicate online activities to the advertisement engine 120 utilizing the network 110. In response, the advertisement engine 120 may provide advertisements that are emotionally compatible to assigned emotional states of the users of the client devices 130.

The advertisement engine 120 selects the advertisements that are transmitted via network 110 to the client devices 130. In turn, the client devices 130 display the advertisements to the users. The advertisers 140 transmit targeting information to the advertisement engine. The targeting information includes desired emotional state, time of day, gender, location, income, and other demographic information for the audience targeted by the advertisers 140. In some embodiments, the targeting information may specify that certain criteria are required and other criteria are optional. For instance, an advertiser 140 may indicate that location criteria, Seattle, is a required criteria but time of day, afternoon, is an optional criteria. Also, the advertisement engine 120 receives advertiser bids. The advertiser bids specify an amount an advertiser is willing to pay to have its advertisement selected by the advertisement engine and transmitted to a client device 130 for rendering when its targeting information is satisfied. In certain embodiments, the advertiser bids may be raised or lowered based on the number of targeting criteria satisfied by the users of the client device that will receive the advertisement. In another embodiment, the advertisers 140 provide the advertisement engine 140 with multiple advertisements, where the advertisements vary as a function of the satisfied targeting criteria. The advertisement engine 120 stores the advertisements and targeting information in the advertisement database 160.

In some embodiments, the advertisement engine 120 is configured to detect emotional shifts in a geographic location. The emotional shifts may be used by the advertisement engine 120 to normalize emotional states that are assigned to users. The advertisement engine 120 may specify moving averages that establish the range for the emotional states. For instance, if there is news about an imminent economic crash in California, the assigned emotional state of users in California may include a high number of “anxious” or negative emotional states. To account for these sudden shifts, the advertisement engine 120 includes “adjusting averages” that normalize the distribution of emotional states. A user shouting during an online game may be assigned an emotional state of moderately angry, slightly angry, or very angry based on number of users assigned an emotional state of angry or the normalized number of users assigned an emotional state of angry. Thus, the emotional states may be assigned to maintain a normalized distribution within, or among, the various emotional states.

The client devices 130 are utilized by users to generate search terms and to receive results having advertisements that are relevant to the search terms. Also, the client devices 130 may be used to capture online activity performed by the users. The online activities are processed to assign emotional states to the users. The emotional states assigned to the users are provided to the advertisement engine 120, which delivers emotionally compatible advertisements to the users. In some embodiments, the online activities are processed by the client devices 130 to identify the emotional state of the users. In other embodiments, the client devices 130 transmit the online activities of the user to the advertisement engine 120, which processes the online activities to assign emotional states to the users and then delivers emotionally compatible advertisements to the users.

The client devices 130 include, without limitation, personal digital assistants, smart phones, laptops, personal computers, gaming devices, or any other suitable client computing device. In some embodiments, the client devices include image capture and voice capture devices. The image capture devices include cameras, video cameras, etc. The voice capture devices include microphones, recorders, etc. The client devices 130 include a user and system information storage to store user and system information on the client device. The user information may include search histories, cookies, user identifiers, online activities, assigned emotional states, and passwords. The system information may include Internet protocol addresses, cached Webpages, and system utilization.

The advertisers 140 provide targeting information, keywords, bids for keywords, bids for targeting data, and advertisements to the advertisement engine 120. The targeting information, keywords, bids for keywords, bids for targeting data, and advertisements are stored in the advertisement database 160. The advertiser 140 promotes goods or services with the advertisements.

In other embodiments, the advertiser 140 may opt-in to parameter targeting provided by the advertisement engine 120. The parameter targeting allows the advertiser 140 to vary a maximum bid for search terms received by the advertisement engine 120. In one embodiment, advertisers 140 may select desired emotional states for users targeted to receive the advertisements stored in the advertisement database 160. The advertisers may select emotional states such as happy, sad, fearful, anxious, tired, excited, etc. Alternatively, the advertiser may select from a hierarchical cluster of emotional states with root emotional states “positive,” “neutral,” or “negative.” Within each root, emotional state may be related by additional hierarchical relationships. For instance, the “positive” emotional state may have child emotional states: surprise, happy, and amusement. The “happy” emotional state may include child states of pleased, glad, etc.

The advertisers 140 may also target an intensity of the emotional states. Advertisers can specify “very angry,” “moderately angry,” or “slightly angry.” In some embodiments, the intensity of the emotional state changes with time. Thus, a user that is assigned a “moderately angry” emotional state may move to an emotional state of “very angry” or “slightly angry” based on the monitored online activities and timing of activities or events that inflame or extinguish the current emotional state.

In an embodiment, the advertisers 140 may also target a length of time a user was assigned an emotional state. The length of time may be the consecutive length of time or an average length of time per day. For instance, the advertiser may target users that are “happy for 1 hour,” “happy for 12 hours,” “happy for 24 hours,” etc. Thus, a user satisfying the emotional state targeting information provided by the advertiser may receive an advertisement stored in the advertisement database 160 at the client device 130.

In some embodiments, advertisers 140 tag the advertisements with emotional states. The emotional state tags may be utilized by the advertisement engine 120 to select the appropriate advertisement. Each advertiser 140 may include several advertisement based on the emotional states that the advertiser 140 intends to target. For instance, an advertiser 140 may upload three advertisements of the same product. Each advertisement may be tagged by the advertiser 140. The first advertisement may be tagged as “positive.” The second advertisement may be tagged as “neutral.” And the third advertisement may be tagged as “negative.” The advertisement engine 120 will select an appropriate version of the advertisement based on the assigned emotional state of the user.

The emotional state database 150 stores assigned emotional states. The emotional state database 150 may be stored locally on the client device 130 or remotely in a separate storage location on the network 110. The assigned emotional states are associated with user identifier and include a time stamp that indicates when the emotional state was assigned to the user. The advertisement engine uses the assigned emotional states of the users and the advertiser targeting information to select appropriate advertisements for delivery to the users.

The advertisement database 160 stores advertisements. The advertisement database 160 also stores the keywords, targeting information, and bids associated with each advertisement. In some embodiments, the advertisements are banner advertisements, display advertisements, text, images, contextual advertisements, search advertisements, audio advertisements, or mobile advertisements that describe a good, service, or thing that an advertiser wishes to promote to users. The things described in the advertisements may include events and items from all over the world, from various merchants, and from various distributors. The advertisements are selected by the advertisement engine 120 and delivered to the client devices 130 based on emotional compatibility and monetization values.

One of ordinary skill in the art understands and appreciates that the computing environment 100 has been simplified for description purposes and alternate operating environments are within the scope and spirit of this description.

In certain embodiments, an advertisement engine obtains online activity from a client device. The advertisement engine processes the online activity to assign an emotional state to a user of the client device. The emotional state is stored in an emotional state database. In an embodiment, the advertisement engine selects a set of advertisements from the advertisement database that are emotionally compatible based on the assigned emotional states stored in the emotional state database. In turn, the selected emotionally compatible advertisements are transmitted to the client device for rendering based on targeting information stored in an advertisement database.

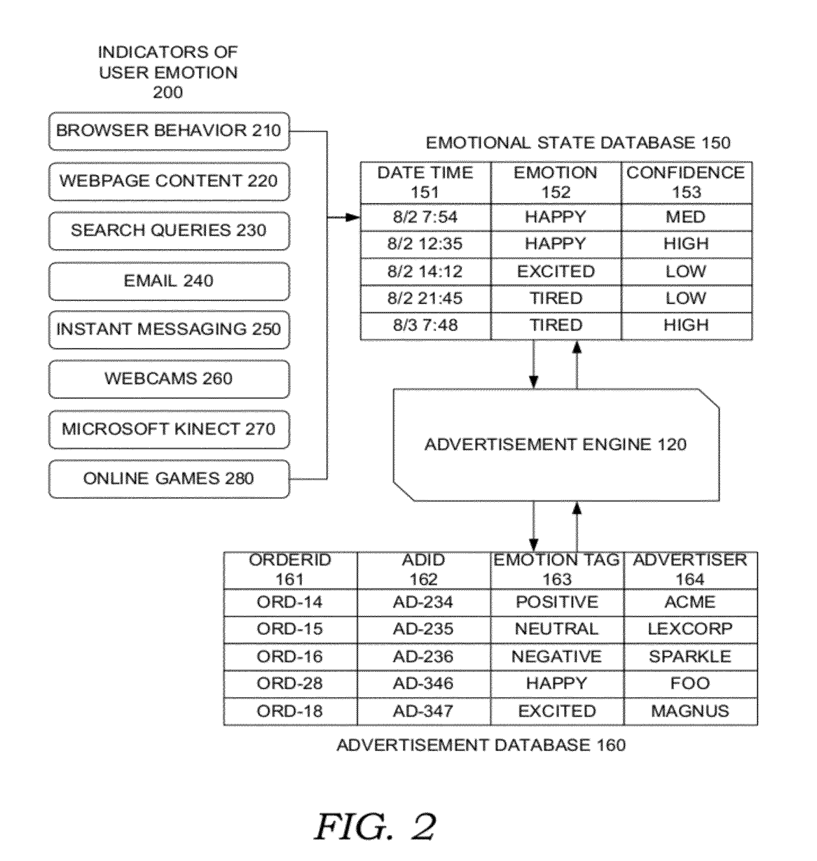

FIG. 2 is a block diagram that illustrates exemplary emotional states utilized by an advertisement engine 120 in the computing environment to target advertisements, according to embodiments of the invention. The advertisement engine 120 is connected to an emotional state database 150 and advertisement database 160. The advertisement engine 120 may receive indicators of user emotion 200 from client devices. In turn, the advertisement engine 120 provides appropriate advertisements to the client devices.

The indicators of user emotions 200 are captured by the client devices. The indicators of user emotion include, but are not limited to, browser behavior 210, webpage content 220, search queries 230, email 240, instant messages 250, videos from webcams 260, gestures from a computing device, e.g., Microsoft Kinect™ 270, and results from online games 280. The indicators of user emotions 200 are processed to assign emotional states to the user. In some embodiments, the client device processes the indicators of user emotion 200 to assign the appropriate emotional state to the user. In other embodiments, the advertisement engine 120 processes the indicators of user emotion 200 to assign the appropriate emotional state to the user.

The emotional state database 150 stores the assigned user emotion extracted from the indicators of user emotion 200. The browser behavior 210 is examined to determine the types of webpages that a user is accessing. If the user is accessing several sites about illness or diseases, the advertisement engine 120 may assign a negative emotional state, such as, anxious, sad, or nervous, to the user.

The webpage content 220 is parsed to determine the type of content that a user is reading. If the user is reading webpage content 220 about crime or accidents, the advertisement engine 120 may assign a negative emotional state, such as, fear or worry, to the user.

The search queries 230 are examined to determine a sequence of search terms entered into a search engine by the user. If the sequence in the search queries for the user includes “vacation,” “deals,” “airplane,” “skydiving,” “excursions,” the advertisement engine 120 may assign a positive emotional state, such as, excited to happy, to the user.

The email 240 to and from the user is parsed to determine the type of content that a user is reading or writing. If the user is reading or writing an email 240 about searching for a job, the advertisement engine 120 may assign a neutral emotional state, such as, stable or content, to the user.

The instant messages 250 to and from the user are parsed to determine the type of content that a user is reading or writing. If the user is reading or writing an instant message 250 about an engagement proposal, the advertisement engine 120 may assign a positive emotional state, such as, adventurous or excited, to the user.

The videos or images from webcams 260 are analyzed for body movement and facial expression to determine whether the user is smiling, frowning, screaming, etc. If the user on the videos or images from the webcams 260 is smiling, the advertisement engine 120 may assign a positive emotional state, such as, happy, to the user. If the user on the videos or images from the webcams 260 is dancing, the advertisement engine 120 may assign a positive emotional state, such as, glad or happy, to the user.

Similarly, the voice and gestures from the computing device, e.g., Microsoft Kinect™ 270, may be analyzed for speech patterns, body movement, and facial expression to determine whether the user is smiling, frowning, screaming, etc. If the user on the videos or images from the computing device, e.g., Microsoft Kinect™ 270, is screaming, the advertisement engine 120 may assign a negative emotional state, such as, upset, to the user. If the user on the videos or images from the computing device, e.g., Microsoft Kinect™ 270, is pacing back and forth, the advertisement engine 120 may assign a negative emotional state, such as, worried, to the user.

The results from online games 280, including statistics about number of wins, draws, or losses, for a user are examined to determine whether the user has won or lost. If the results from online games 280 for the user indicate that the user lost, the advertisement engine 120 may assign a negative emotional state, such as, depressed, to the user. If the results from online games 280 indicate that the user won, the advertisement engine 120 may assign a positive emotional state, such as, happy, to the user.

Additionally statistics of a user's performance during a game are examined to determine whether the user has achieved special recognition, arrived to a battle or challenge level, unlocked a hidden feature, repeated a level more than a threshold number of times, or played for more than a threshold number of hours. These statistics may be analyzed to assign the user one of the following emotional states: excited, frustrated, or fatigued. For instance, if the threshold number of hours is 5 hours of continuous play, and the user has logged 7 hours of continuous play the user may be assigned an emotional state of fatigued. Similarly, if the threshold number of times is 3 times for repeating a level, and the user has repeated the same level 5 times the user may be assigned an emotional state of frustrated. The user may be assigned an emotional state of excited when the user achieves special recognition, arrives at a battle or challenge level, or unlocks a hidden feature.

The emotional state database 150 stores a user identifier field, a timestamp field 151, the assigned emotion field 152, and a confidence level field 153. The advertisement engine 120 may store the assigned emotions for the users in the emotional state database. The user identifier may be anonymous cookies or an alias created by the user. The timestamp field 151 represents a time that a user is assigned an emotional state stored in the emotional state database 150. Previous timestamp entries in the emotional state database 150 should not be deleted upon assigning additional emotions to a user because sequences of emotions may be used by the advertisement engine 120 to identify a degree or intensity of the assigned emotional state. Further, the confidence level field 153 stored in the emotional state database 150 stores the statistical confidence that the assigned emotion represents an actual user emotion. In one embodiment, the statistical confidence is based on a controlled sample group of users that provide feedback on the emotional states assigned to them by the advertisement engine 120.

The advertisement engine 120 selects advertisements from the advertisement database based on the assigned emotional states. For instance, a user, Tom woke up worrying about a test today at school. He took the test in the morning and completely bombed it. He was depressed all throughout the day. Afterschool, one of his friends instant messages him saying that the teacher has decided to cancel the test grade as there were some errors in some questions. Tom is exhilarated. He jumps online to play a game with his friend. The scenario above provided the following advertising opportunities during Tom's day: [A] 8:27 am Tom sends an email to his friend; [B] 12:13 pm Tom goes online during lunch browsing webpages; [C] 3:47 pm Tom uses a search engine to do some research; [D] 6:05 pm Tom chats with a friend online; [E] 9:36 pm Tom plays a game with his friend on a gaming device, e.g., Microsoft Kinect™; [F] 11:13 pm Tom sends an email to his grandmother. The advertisement engine 120 would have several opportunities to assign an emotional state to Tom. The advertisement engine 120 may assign increasingly negative emotional states during Tom's day. So, the advertisement engine 120 may select advertisements associated with negative emotional states until [D] when Tom learns that the test grades will be canceled. At that moment, the advertisement engine 120 may assign a happy emotional state to Tom. In [E] and [F], the advertisement engine 120 confirms that Tom is happy through body motion he displayed playing an action game on the gaming device, e.g., Microsoft Kinect™ with his friend as well as the vocabulary and style of writing in his email to his grandmother. The advertisement engine 120 may select advertisements associated with happy emotional states from [D] to [F] for display to Tom.

In some embodiments, the advertisement engine 120 decays the assigned emotional state. For instance, a user assigned a very happy emotional state, is automatically assigned a happy emotional state by the advertisement engine if no additional online activity is obtained within a threshold period of time, e.g., 24 hours from last online activity for the user. If the threshold period of time passes again, the user is automatically assigned an emotional state of neutral, where the assigned emotional state stays until the advertisement engine 120 obtains online activity for the user. If the last assigned emotional state for a user was several days, the advertisement engine 120 assigns a neutral emotional state to the user to indicate that no current emotional state data is available for the user.

The advertisement engine 120 selects the advertisements from the advertisement database 160. The advertisement database 160 stores an order ID field 161, Ad ID field 162, emotion tag field 163, and an advertiser field 164. The order ID field identifies each entry in the advertisement database 160. The Ad ID field identifies the advertisements associated with each entry in the advertisement database 160. The emotion tag field 163 stores the emotional state assigned to advertisement by the advertiser. In an alternate embodiment, the advertisement engine 120 may parse the advertisements using natural language technology to automatically determine an emotional state for the advertisement. In turn, the advertisement engine 120 may store the determined emotional state in the emotion tag field 163. The advertiser field 164 stores the name of advertisers that provide the advertisements and targeting information stored in the advertisement database 160. In certain embodiments, the advertisement database 160 includes a time field that specifies a length of time the user is assigned a desired emotional state identified by the advertiser. The advertisement database includes a bid field that stores the bids for the advertisements that may vary as a function of the emotional tag field and time field.

In some embodiments, assigned emotional states for users are used to target appropriate advertisements to the users. Online activities for the users are obtained. In turn, the online activities are processed to identify tones for one or more content associated with the online activities. The users' reactions to the content are received and emotional states are assigned to the users based on the users' reaction and the tone.

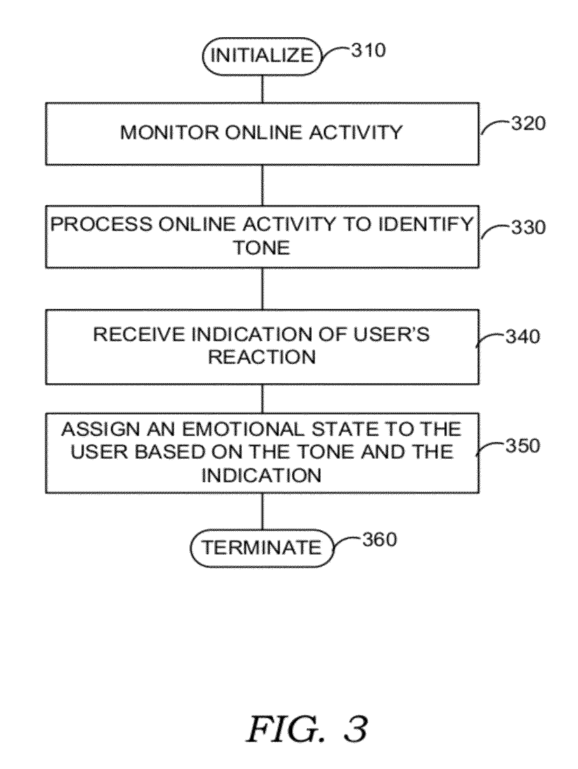

FIG. 3 is a logic diagram that illustrates an exemplary computer-implemented method for determining emotional states, according to embodiments of the invention. The method initializes in step 310. In turn, a user's online activity during a time period is monitored, in step 320. In one embodiment, the online activity may be stored in a log. The online activity comprises browsing history, webpage content, search queries, emails, instant messages, and online games.

In step 330, the online activity is processed to identify a tone associated with content that the user interacted with during the time period. An indication of the user's reaction to the content is received in step 340. The indication of the user's reaction is identified from facial expressions of the user captured by an image capture device during the time period. In another embodiment, the indication of the user's reaction is identified from gestures and body movements of the user captured by an image capture device during the time period. Alternatively, the indication of the user's reaction may be identified from user speech patterns captured by an audio capture device during the time period.

In step 350, an emotional state is assigned to the user based on the tone of the content and the indication of the user's reaction to the content. The emotional state assigned to the user is stored in a database. In some embodiments, the assigned emotional state is any of: positive, happy, confused, neutral, negative, angry, or sad. In certain embodiments, the assigned emotional state is associated with a duration. The method ends in step 360.

In summary, a computer system targeting advertisements based on emotion includes an emotional state database, an advertisement database, and an advertisement engine. The emotional state database is configured to store the emotional states assigned to users. The advertisement database is configured to store advertisements and targeting information. The advertisement database associates an advertisement and an emotional state of the advertisement as specified by the advertiser for the advertisement. In one embodiment, the advertisement database includes a length of time targeted users are associated with the desired emotional state.

The advertisement engine is configured to receive the targeting information, wherein the targeting information includes the desired emotional states of users that advertisers intend to target. In some embodiments, the advertisement engine processes a request for an advertisement, wherein the request includes an identifier for a user. The advertisement engine checks the emotional state database having user identifiers and assigned emotional states to determine the assigned emotional state of the user associated with the identifier included in the request.

If the user identifier is in the emotional state database, the advertisement engine retrieves the assigned emotional state of the user and selects from the advertisement database advertisements based on the desired emotional state and the other targeting criteria. The other targeting criteria may be related to the user or content. The other targeting criteria may include zip code, keywords, age, location, or language.

If the user identifier is not in the emotional state database, the advertisement engine selects an advertisement based on the other targeting criteria. In other embodiments, if the user identifier is not in the emotional state database, the advertisement engine determines the emotional state of the user and selects the advertisement based on the determined emotional state.

The advertisement engine may transmit the selected advertisement based on monetization value, where the monetization value may be based on advertiser bids. Thus, the advertisement engine provides emotionally compatible advertisements to a user based on monetization value. No paintball gun advertiser wants its advertisements to appear next to news about vicious gun fights or wars. Because, generally, people's emotion toward guns and weapons tend to be negative after reading or hearing the news. Weight-loss product advertisers may not want their advertisement to appear to users that are very happy. Because, a person that is really happy, is less likely to purchase a self-investment product that leverages on his or her shortcomings. But a really happy person may purchase electronic products or vacation packages. No club or party advertisers want to appear when the user is sad or crying. When the user is emotionally sad, advertisements about club parties would not be appropriate and may seem annoying or negative to the user. Online help or technical support advertisers want their advertisements to appear when the user is demonstrating a confused or frustrated emotional state. Advertisers using the advertisement engine are more likely to surface emotionally compatible advertisements to users.

For instance, OMG the advertiser discussed above, used emotional targeting and updated their advertising campaign. OMG decided to show its advertisement only to users assigned a happy emotional state. OMG noticed that the number of unique customers slowly declined. A research firm, contracted by OMG, now reported that OMG's brand awareness had plummeted. Essentially, people who knew of OMG had a positive reaction to the brand but not many people knew about OMG.

OMG understood that because it only showed its advertisements to a very limited set of people, those who happened to be assigned an emotionally positive state, e.g., happy, the advertisement was working for that segment of the population. OMG decided to create multiple advertisements for the advertisement engine to select from that varied as a function of emotional state.

Two new advertisements were created by OMG. The first new advertisement was a lounge setting with a subtle cocktail and a silhouette of people around one person. Nothing was animated in the first new advertisement. The first new advertisement gave a sense of a high-class business lounge. The second new advertisement listed all the activities offered by OMG with small icons representing each activity. Then OMG assigned emotion tags for each of the three advertisements. For the original advertisement (Bowling BANG), OMG assigned “positive,” “exciting,” and “happy” emotional states. For the first new advertisement (Night Lounge), OMG assigned “neutral” and “comforting” emotional states. For the second new advertisement (Activity Icons) OMG assigned “negative,” “sad,” and “lonely” emotional states. OMG opted-in to advertisement targeting based on compatibility between the emotional tag and the assigned emotional states of the users.

Thus, the advertisement engine may select the advertisements to be in-tune with the user's assigned emotional state. For instance, three users are online and are assigned varying emotional states. User A is ecstatic that he just got a promotion. User B is wondering what to do with her friend this weekend. User C is sad. User A browses through the internet and is looking at reviews for action films. The advertisement engine assigns an emotional state to User A. During the browsing session OMG's advertisement is displayed to User A. The advertisement engine selected the original advertisement with the bowling ball, the smashing pins, and the fireworks. User A clicks on OMG's advertisement to find out more. User B is wondering what to do with her friend this weekend. She is assigned a neutral emotional state by the advertisement engine because she has not been online in three days. She had a big project at work and has not been online for several days. The advertisement engine selects OMG's first new advertisement. User B clicks on OMG's first new advertisement to find out more. User C just read an email online from his friend saying he was selfish and mean. User C is assigned a negative emotional state by the advertisement engine. User C has children, and they want to go somewhere fun for the weekend. The advertisement engine selects OMG's second new advertisement. The advertisement lists the offered activities. User C clicks on OMG's second new advertisement for additional details.

Accordingly, the advertisement engine may deliver advertisements based on targeting information that includes desired emotional states of users the advertisers intend to target. Alternatively, in some embodiments, the advertisement engine may receive, from advertisers, emotional states for advertisements provided by the advertisers for storage in the advertisement database. Thus, without targeting information that includes desired emotional states, the advertisement engine may select emotionally compatible advertisements for delivery to the users.

The foregoing descriptions of the embodiments of the invention are illustrative, and modifications in configuration and implementation will occur to persons skilled in the art. For instance, while the embodiments of the invention have generally been described with relation to FIGS. 1-3, those descriptions are exemplary. Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing the claims. The scope of the embodiments of the invention is accordingly intended to be limited only by the following claims.

We claim:

1. A computer-implemented method to determine emotional states of users that receive advertisements on client devices, the method comprising:
monitoring a user's online activity during a time period;
processing the online activity to identify a tone associated with content that the user interacted with during the time period;
receiving an indication of the user's reaction to the content; and
assigning an emotional state to the user based on the tone of the content and the indication of the user's reaction to the content.

2. The computer-implemented method of claim 1, wherein the online activity is stored in a log.

3. The computer-implemented method of claim 1, wherein the online activity comprises browsing history, webpage content, search queries, emails, instant messages, and online games.

4. The computer-implemented method of claim 1, wherein the indication of the user's reaction is identified from facial expressions of the user captured by an image capture device during the time period.

5. The computer-implemented method of claim 1, wherein the indication of the user's reaction is identified from user speech patterns captured by an audio capture device during the time period.

6. The computer-implemented method of claim 1, wherein the indication of the user's reaction is identified from gestures and body movements of the user captured by an image capture device during the time period.

7. The computer-implemented method of claim 1, further comprising storing the emotional state of the user in a database.

8. The computer-implemented method of claim 7, wherein the emotional state is one of: positive, happy, confused, neutral, negative, angry, or sad.

9. The computer-implemented method of claim 8, wherein the emotional state is assigned a duration.

10. A computer system, the computer system comprising:
an emotional state database configured to store the emotional states assigned to users;
an advertisement database configured to store advertisements and targeting information; and
an advertisement engine configured to receive the targeting information, wherein the targeting information includes the desired emotional states of users that advertisers intend to target, and the advertisement engine:
processes a request for an advertisement, wherein the request includes an identifier for a user, checks the emotional state database having user identifiers and assigned emotional states to determine the assigned emotional state of the user associated with the identifier included in the request,
if the user identifier is in the emotional state database, the advertisement engine retrieves the assigned emotional state of the user and selects from the advertisement database advertisements based on the desired emotional state and the other targeting criteria, wherein the other targeting criteria is related to the user or content,
if the user identifier is not in the emotional state database, the advertisement engine selects an advertisement based on the other targeting criteria, and
transmits the selected advertisement based on monetization value.

11. The computer system of claim 10, wherein if the user identifier is not in the emotional state database, determining the emotional state of the user.

12. The computer system of claim 10, wherein the other targeting criteria include zip code, keywords, age, location, or language.

13. The computer system of claim 10, wherein the monetization value is based on advertiser bids.

14. The computer system of claim 10, wherein the advertisement database associates an advertisement and an emotional state of the advertisement as specified by the advertiser for the advertisement.

15. The computer system of claim 14, wherein the advertisement database includes a length of time of users the advertisers intend to target is associated the desired emotional state.

16. One or more computer readable media storing computer-useable instructions to determine an emotional state, the method comprising:
monitoring a user's online activity during a time period;
processing the online activity to identify a tone associated with content that the user interacted with during the time period;
receiving an indication of the user's reaction to the content; and
assigning an emotional state to the user based on the tone of the content and the indication of the user's reaction to the content.

17. The media of claim 16, wherein the assigned emotional state is normalized based on the statistical average of emotional states assigned to users having processed online activity during the time period.

18. The media of claim 16, wherein the online activity comprises browsing history, webpage content, search queries, emails, instant messages, and online games.

19. The media of claim 16, wherein the indication of the user's reaction is identified from facial expressions of the user captured by an image capture device during the time period.

20. The media of claim 16, wherein the indication of the user's reaction is identified from user speech patterns captured by an audio capture device during the time period.
